(19) United States
(12) Patent Application Publication
(10) Pub. No.: US 2025/0026605 A1
(43) Pub. Date: Jan. 23, 2025

(54) PORTABLE WALL BASE COIL UNWINDING APPARATUS AND RELATED METHODS

(71) Applicant: David Low, Centralia, WA (US)

(72) Inventor: David Low, Centralia, WA (US)

(21) Appl. No.: 18/225,037

(22) Filed: Jul. 21, 2023

(51) Int. Cl. B65H 49/20; B65H 49/28; B65H 75/02

(52) U.S. Cl. CPC B65H 49/205; B65H 49/28; B65H 75/02; B65H 2402/351; B65H 2402/41

(57) ABSTRACT

The invention pertains to a portable wall base coil unwinding device. The device includes a base caddy, a turntable, a lazy Susan swivel connector, three concentric wall base coil holders, three removable wall base coil holder extension tubes, and at least three freely rotatable and swivable wheels. The device is designed to accommodate different sizes of wall base coils and allows for easy loading and unloading of the coils. The invention also includes a method for unwinding and positioning a wall cove base material along the base of a wall using the device.

### TECHNICAL FIELD

The present invention relates generally to the field of coil handling and unwinding devices. More specifically, the invention pertains to a portable wall base coil unwinding device designed to accommodate and efficiently dispense multiple sizes of base coils.

### BACKGROUND OF THE INVENTION

In various industries, such as construction and manufacturing, base coils are commonly used for a wide range of applications. These coils are typically wound around a core and need to be unwound for proper utilization. Handling and unwinding these coils can be challenging, particularly when dealing with different sizes of base coils.

Wall base, also known as baseboard or skirting, is a material typically installed along the base of an interior wall to cover the joint between the wall and floor. It is often supplied in coiled form, which can be cumbersome to handle and install, particularly in large or complex spaces.

Traditional methods of installing wall base involve manually unwinding the coil, cutting the material to the required length, and then positioning and securing it along the base of the wall. This process can be time-consuming, labor-intensive, and prone to errors, such as uneven positioning or damage to the material.

Various devices have been proposed to assist with the handling and installation of coiled materials. However, these devices often lack the flexibility to accommodate different sizes of coils, or they may not provide sufficient support to the coil during unwinding, leading to tangling or damage. Furthermore, these devices may not allow for smooth and controlled unwinding of the coil, which can result in uneven positioning of the material.

Because the positioning and installing base coil along the base of a wall is very labor intensive, there is still a need in the art for new and improved tools and methods for unwinding and positioning/installing of various sizes of base coil along the base of a wall. The present invention fulfills this need and provides for further related advantages

### SUMMARY OF THE INVENTION

In one embodiment, a portable wall base coil unwinding device includes a base caddy, a turntable, a lazy Susan swivel connector, three concentric wall extension tube holders, three removable wall base coil holder extension tubes, and at least three freely rotatable and swivable wheels. The base caddy has a topside and a bottom side. The turntable is positioned above the topside of the base caddy and is rotatably connected to the base caddy by the lazy Susan swivel connector.

The extension tube holders are centrally positioned on the turntable and are sized and configured to receive and retain a coil of wall base of a selected size. The wall base coil holder extension tubes are frictionally engagable about the three concentric extension tube holders. The wheels are positioned on the bottom side of the base caddy.

In another embodiment, the base caddy, the turntable, the lazy Susan swivel connector, the extension tube holders, the wall base coil holder extension tubes, and the wheels are made of durable materials.

In yet another embodiment, the lazy Susan swivel connector allows for 360-degree rotation of the turntable relative to the base caddy.

Additionally, the wall base coil holders may be adjustable to accommodate different sizes of wall base coils.

Alternatively, the wall base coil holder extension tubes may be removable to allow for easy loading and unloading of the wall base coils.

In one embodiment, a method for unwinding and positioning a wall cove base material along the base of a wall includes providing a device according to claim 1, loading a coil of wall base onto one of the wall base coil holders, rotating the turntable to unwind the coil of wall base, and positioning the unwound wall base along the base of a wall.

In another embodiment, the method further includes removing the wall base coil holder extension tube to load the coil of wall base onto the wall base coil holder.

In yet another embodiment, the method further includes rotating the turntable using the lazy Susan swivel connector.

Additionally, the method may include moving the device along the base of the wall using the wheels.

Alternatively, the wall base may be positioned along the base of the wall without requiring manual unwinding of the coil.

In some embodiments, the wall base is positioned along the base of the wall in a continuous, smooth manner.

In one embodiment, the base caddy is lightweight and portable.

In another embodiment, the turntable, the wall base coil holders, and the wall base coil holder extension tubes are designed for easy assembly and disassembly.

These and other aspects of the present invention will become more readily apparent to those possessing ordinary skill in the art when reference is made to the following detailed description in conjunction with the accompanying drawings.

### BRIEF DESCRIPTION OF DRAWINGS

The drawings are intended to be illustrative of certain preferred embodiments of the present invention. Like reference numerals have been used to designate like features throughout the several views of the drawings.

FIG. 1 is an elevated perspective view of the portable wall base coil unwinding device 100, showing the base caddy 110, the turntable 120, the lazy Susan swivel connector 130 (not shown in FIG. 1), the three concentric extension tube holders 131, 132, 133 separated by first and second circular grooves 134, 135, respectively, and the three freely rotatable and swivable wheels 150 in accordance with an embodiment of the invention. Not shown are the three removable wall base coil holder extension tubes 141, 142, 143, respectively.

FIG. 2 is a first side view of the portable wall base coil unwinding device 100 shown in FIG. 1.

FIG. 3 is a second side view of the portable wall base coil unwinding device 100 shown in FIG. 1.

FIG. 4 is a front view of the portable wall base coil unwinding device 100 shown in FIG. 1.

FIG. 5 is a back view of the portable wall base coil unwinding device 100 shown in FIG. 1.

FIG. 6 is top plan view of the portable wall base coil unwinding device 100 shown in FIG. 1.

FIG. 7 is a bottom plan view of the portable wall base coil unwinding device 100 shown in FIG. 1.

FIG. 8 is an exploded elevated perspective view of the portable wall base coil unwinding device 100 shown in FIG. 1, but where the three removable wall base coil holder extension tubes 141, 142, 143, respectively, are shown disengaged and positioned above the portable wall base coil unwinding device shown in FIG. 1.

FIG. 9 shows a first base coil 160 positioned about a first removable wall base coil extension tube 143.

FIG. 10 shows a second base coil 170 positioned about a second removable wall base coil extension tube 142.

FIG. 11 shows a third base coil 180 positioned about a third removable wall base coil extension tube 143.

### DETAILED DESCRIPTION OF THE INVENTION

In the following detailed description, reference is made to the accompanying drawings, which form a part hereof. In the drawings, similar symbols or markings have been used to identify like or corresponding elements, unless context dictates otherwise. The illustrative embodiments described in the detailed description, drawings, and claims are not meant to be limiting. Other embodiments may be utilized, and other changes may be made, without departing from the spirit or scope of the subject matter presented herein.

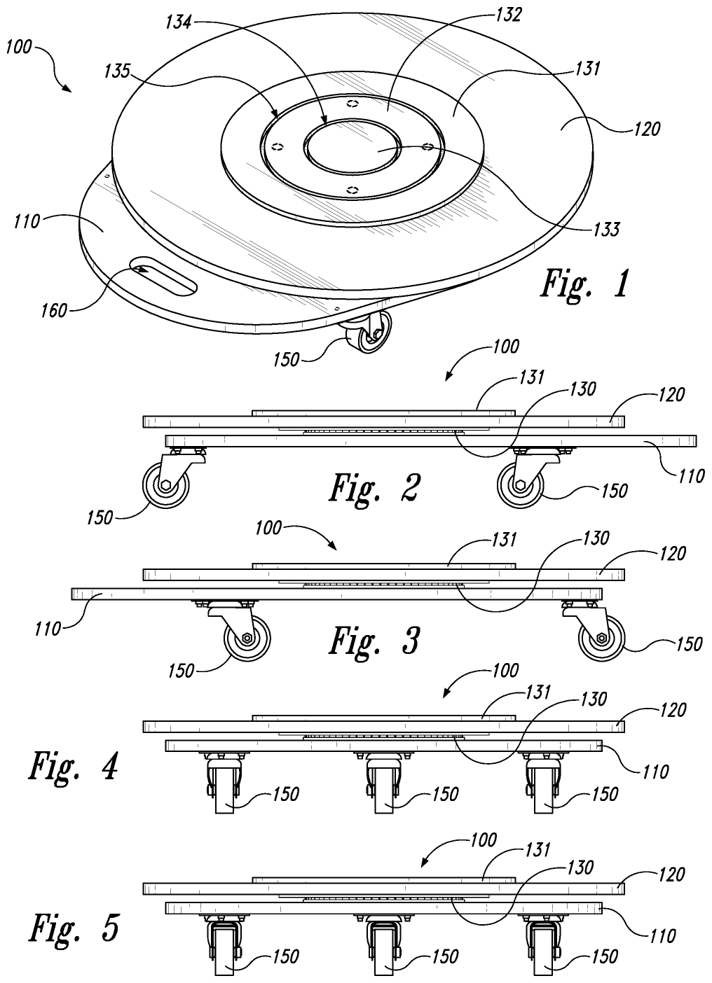

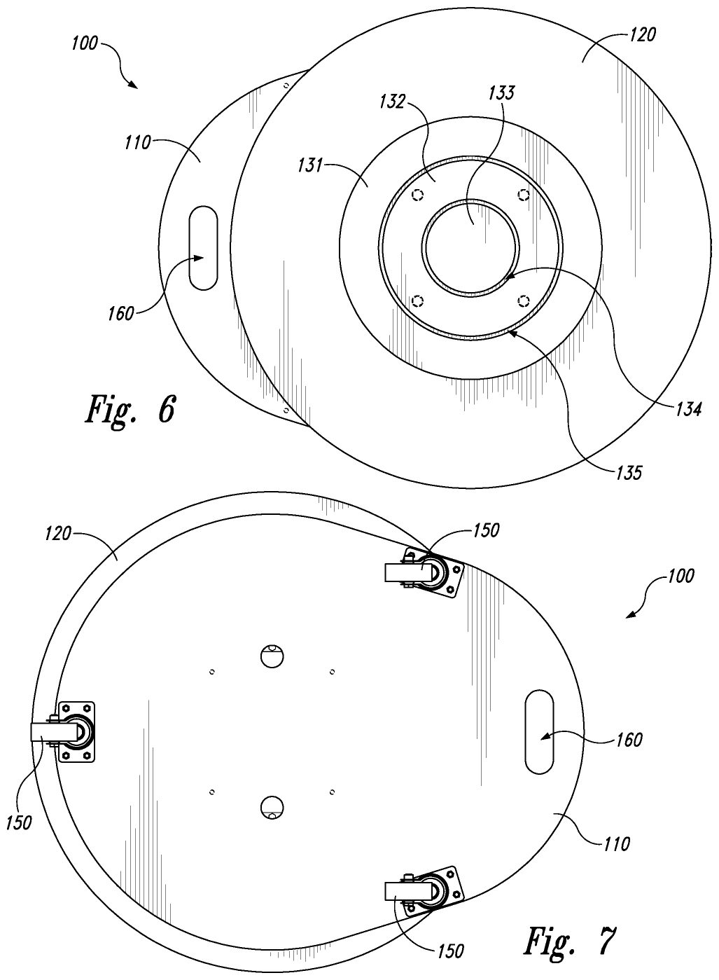

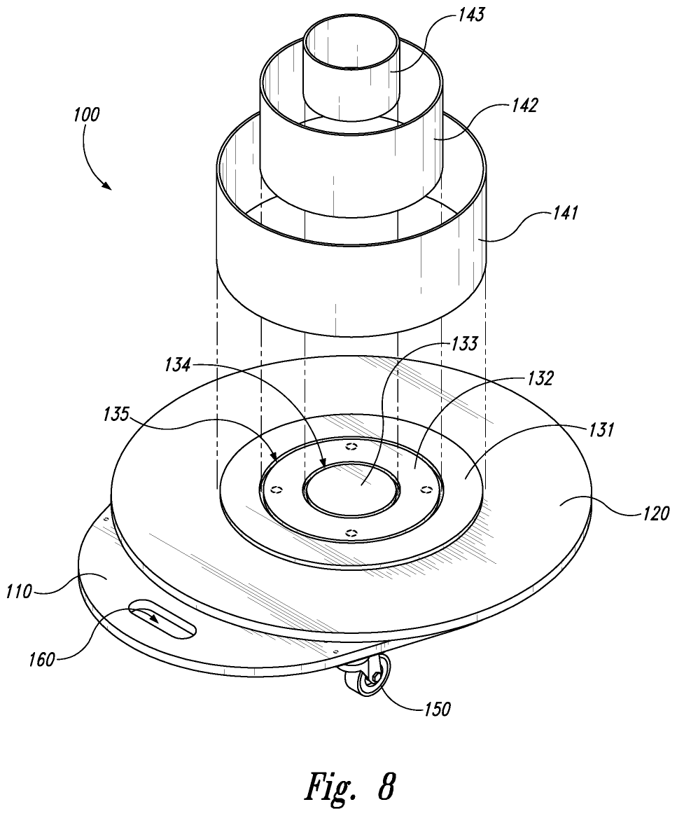

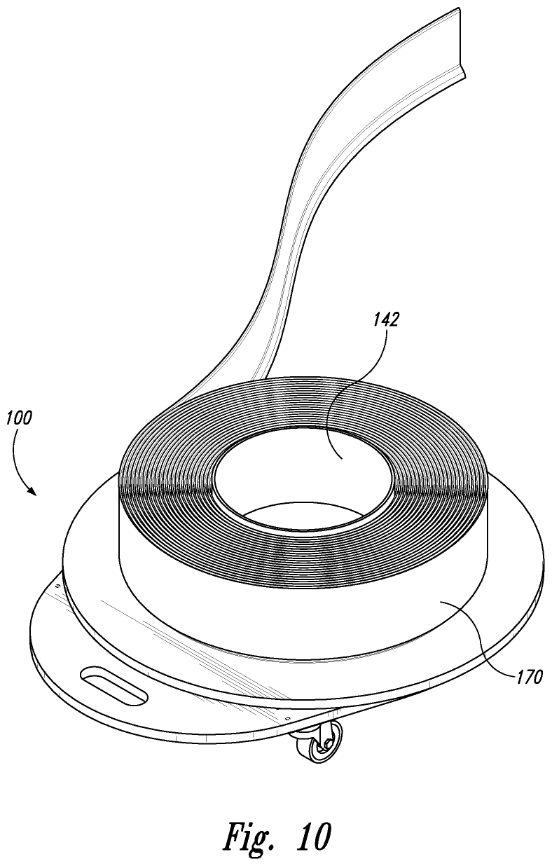

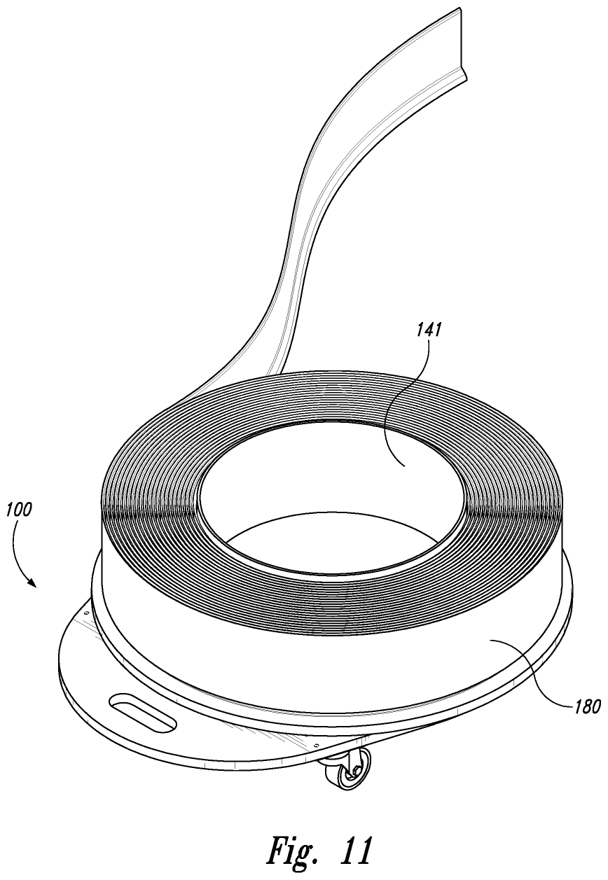

Accordingly, and in view of the foregoing and referring now to the drawings, and more particularly to FIGS. 1-11, the present invention is directed to a portable wall base coil unwinding device 100 useful for unwinding and installing rolls of wall cove base (commonly referred to as “coils”) along the base of a wall. As shown, the inventive portable wall base coil unwinding device 100 comprises a base caddy 110 that has a topside and a bottom side. The base caddy 110 is preferably made out a rigid sheet material (such as, for example, a hard plastic material or 1% inch plywood) that has been shaped or cut (as the case may be) into an oblong shape as shown (preferably having long and short crosswise diameters of about 26 inches and 20% inches, respectively). As shown, a turntable 120 is positioned above the topside of the base caddy 110. The turntable 120 is also preferably made out a rigid sheet material (such as, for example, a hard plastic material or ¼ inch plywood) that has been shaped or cut (as the case may be) into a circular shape as shown (preferably having a diameter of about 22 inches).

As further shown, a lazy Susan swivel connector 130 has been provided to rotatably interconnect the base caddy 110 to the turntable 120. The lazy Susan swivel connector 130 is preferably comprised of a plurality of ball bearings positioned between a pair of opposing square metal plates (that are each preferably about 6×6 inches in dimension). The opposing square metal plates are attached to the topside of the base caddy 110 and the bottom side of the turntable 120 by means of fasteners (such as, for example, a plurality of standard wood screws). In this configuration, the turntable 120 is freely rotatable.

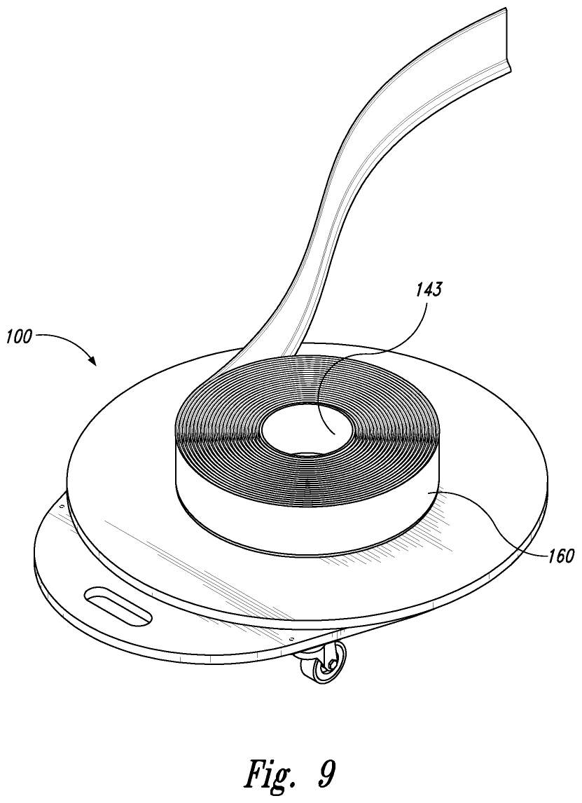

As still further shown, three concentric extension tube holders 131, 132, 133 (separated by first and second circular grooves 134, 135, respectively), have been provided on the topside of the turntable 120. As shown, three concentric extension tube holders 131, 132, 133 have been sized and configured to receive and retain three different sized removable wall base coil holder extension tubes 141, 142, 143 (for holding and retaining a selected size of base coil, wherein the selected base coil fits about one of three concentric extension tube holders 131, 132, 133 as shown in FIGS. 9-11). The turntable 120 is also preferably made out a rigid sheet material (such as, for example, a hard plastic material or 1 inch plywood) that has been shaped or cut (as the case may be) into a circular shape as shown (and preferably having a diameter of about 11% inches). The wall base coil holder 18 is preferably attached to the turntable 14 be means of an adhesive or wood glue (not shown).

The portable wall base coil unwinding device 100 also comprises least three wheels 150 positioned (spaced apart) on the bottom side of the base caddy 110. The at least three wheels 150 are preferably 1½ inch caster wheels (with optional brake tabs) that can each swivel about a vertical axis and rotate about a horizontal axis. In other words, the at least three wheels 150 are preferably freely rotatable and swivable. As shown, the at least three wheels 150 are preferably attached to the bottom side of the base caddy 110 by means of fasteners (such as, for example, a plurality of screws).

In order to facilitate the towing/moving of the portable wall base coil unwinding device 100 along the floor, a tow rope (not shown) of a desired length may be connected to the base caddy 110. And in order to facilitate the carrying of the inventive portable wall base coil unwinding device 100, a slot 160 (that is preferably about 4 inches by about 1¼ inches) may be cut into one end of the base caddy 110 as shown.

In other aspect, the present invention provides an improved tool and method for unwinding and positioning/installing a wall cove base material along the base of a wall. The inventive method comprises at the least the steps of: providing a portable wall base coil unwinding device as disclosed herein; positioning a coil of wall base onto the wall base coil holder that is centrally positioned on the turntable; and unwinding the coil of wall base while moving the portable wall base coil unwinder device along the floor and base of the wall.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

I claim:

1. A portable wall base coil unwinding device, comprising:
a base caddy having a topside and a bottom side;
a turntable positioned above the topside of the base caddy;
a lazy Susan swivel connector rotatably connecting the base caddy to the turntable;
three concentric extension tube holders centrally positioned on the turntable, wherein each extension tube holder is sized and configured to receive and retain an extension tube of a selected size;
three removable wall base coil holder extension tubes frictionally engagable about the three concentric extension tube holders; and
at least three freely rotatable and swivable wheels positioned on the bottom side of the base caddy.

2. The device of claim 1, wherein the base caddy and the turntable are made of wood.

3. The device of claim 1, wherein the lazy Susan swivel connector allows for 360-degree rotation of the turntable relative to the base caddy.

4. The device of claim 1, wherein the wall base coil holder extension tubes are removable to allow for easy loading and unloading of the wall base coils.

5. A method for unwinding and positioning a wall cove base material along the base of a wall, comprising:
providing a device according to claim 1;
loading a coil of wall base onto one of the wall base coil holders;
rotating the turntable to unwind the coil of wall base; and
positioning the unwound wall base along the base of a wall.

6. The method of claim 5, further comprising removing the wall base coil holder extension tube to load the coil of wall base onto the wall base coil holder.

7. The method of claim 6, further comprising rotating the turntable using the lazy Susan swivel connector.

8. The method of claim 7, further comprising moving the device along the base of the wall using the wheels.

9. The method of claim 8, wherein the wall base is positioned along the base of the wall without requiring manual unwinding of the coil.

10. The method of claim 9, wherein the wall base is positioned along the base of the wall in a continuous, smooth manner.

11. The method of claim 10, wherein the wall base is unwound from the coil and positioned along the base of the wall in a single, continuous operation.

12. The method of claim 11, wherein the device is moved along the base of the wall at a controlled speed to ensure accurate positioning of the wall base.
